(19) United States
(12) Patent Application Publication
(10) Pub. No.: US 2010/0167030 A1
(43) Pub. Date: Jul. 1, 2010

(54) ADHESIVE TAPE AND ADHESIVE TAPE ROLL

(75) Inventors: Toshiyuki Yanagawa, Ibaraki (JP); Kazuyuki Watanabe, Ibaraki (JP)

Correspondence Address: GRIFFIN & SZIPL, PC, SUITE PH-1, 2300 NINTH STREET, SOUTH, ARLINGTON, VA, 22204, US

(73) Assignee: HITACHI CHEMICAL COMPANY, LTD., Tokyo (JP)

(21) Appl. No.: 12/447,927

(22) PCT Filed: Oct. 29, 2007
(86) PCT No.: PCT/JP2007/071004

§ 371 Date: Jan. 22, 2010

(30) Foreign Application Priority Data
Oct. 31, 2006 (JP) 2006-295790
Jun. 27, 2007 (JP) 2007-169420

(51) Int. Cl. B32B 7/02

(52) U.S. Cl. 428/212

(57) ABSTRACT

The invention provides an adhesive tape comprising a tape-like support base and a tape-like adhesive layer, wherein the adhesive layer is formed on the main side of the support base and the width of the support base is longer than the width of the adhesive layer. According to the invention, seepage of adhesive components in the adhesive layer of the adhesive tape in the widthwise direction from the sides of the support base can be reduced compared to the prior art.

### TECHNICAL FIELD

The present invention relates to an adhesive tape and to an adhesive tape roll.

### BACKGROUND ART

In recent years, adhesive tapes such as anisotropic conductive films (ACFs) have been used as connecting materials for connection between members with numerous mutually opposing electrodes, that are to be connected together. The members that are to be connected include boards such as printed wiring boards, LCD glass panels or flexible printed boards, or semiconductor elements or packages such as ICs and LSIs. ACFs are used to connect such members together, as connecting materials that maintain the state of conduction between opposing electrodes while accomplishing electrical connection and mechanical anchoring to maintain insulation between adjacent electrodes.

ACFs are usually produced through the following steps. First, a film-like adhesive layer is formed on the main side of a film-like support base. The material of the support base may be, for example, polyethylene terephthalate (PET). The adhesive layer includes, for example, an adhesive component containing a thermosetting resin, and conductive particles mixed therein if necessary. The support base/adhesive layer laminated body is cut (slit) into a tape-like form. The cut tape is wound concentrically around a core to obtain a product as a reel-shaped ACF tape roll with a narrow length. Thermosetting resins employing epoxy resins and the like, which exhibit high adhesive force and high reliability, have conventionally been used in ACF adhesive components (for example, see Patent document 1). Of note recently are radical curing adhesive components that are used together with acrylate derivatives or methacrylate derivatives, and peroxides as radical polymerization initiators (see Patent documents 2 and 3, for example). The radical curing adhesive component is highly reactive with radicals as reactive species, and can therefore cause curing in a short period of time.

[Patent document 1] Japanese Unexamined Patent Publication HEI No. 1-113480
[Patent document 2] Japanese Unexamined Patent Publication No. 2002-203427
[Patent document 3] International Patent Publication No. 98/044067.

### DISCLOSURE OF THE INVENTION

### Problems to be Solved by the Invention

For ordinary formation of an adhesive layer on the main side of a support base, the adhesive layer is formed as a band with a width of about 10-50 cm, and then the laminated body is taken up to form a supply roll. Next, the supply roll is pulled out and cut in the direction orthogonal to the widthwise direction of the supply roll, to a narrow width of about 0.5-5 mm, using the cutting blade of a cutter, for example, to form an ACF, and then taken up again.

FIG. 5 shows a schematic cross-sectional view of a conventional ACF. FIG. 5 shows the cross-sectional shape orthogonal to the lengthwise direction of the ACF, with top and bottom reversed, after formation of the adhesive layer on the main side of the support base. Since the supply roll is cut in the direction orthogonal to the widthwise direction, the cross-sectional shapes of the support base 41 and adhesive layer 42 orthogonal to the lengthwise direction of the ACF 40 are both flat rectangular. Also, since the laminated body is cut to a narrow width after the adhesive layer has been formed on the main side of the support base, the adhesive layer 42 is formed over the entire surface of the main side on one side of the support base 41 in the ACF 40, and the widths (a, a′, b, b′) of the support base 41 and adhesive layer 42 are identical.

FIG. 6 is a schematic cross-sectional view showing a portion of a narrow-width, long ACF tape roll 50, obtained by taking up onto a reel a conventional ACT 40 having the cross-sectional shape shown in FIG. 5. The cross-section is taken orthogonal to the lengthwise direction of the ACF tape. When the ACF 40 is in this wound up state, the adhesive layer 42 becomes sandwiched between the support base 41 and pressed in the direction of lamination. This causes the adhesive components in the adhesive layer 42, and especially the low viscosity components, to seep out in the widthwise direction of the ACF 40. The areas of seepage 425 cover the sides of the support base 41, and in extreme cases the sides of the support base 41 may become completely covered by the areas of seepage 425 of the adhesive layers 42 above and below. When this occurs, and it is attempted to pull the ACF 40 out from the ACF tape roll 50, the ACF 40 being pulled out attaches to the ACF 40 on the inside such that the roll cannot be easily pulled out.

The ACF tape roll 50 is often wound on a reel having a winding core and side plates on both edges of the winding core, so as to facilitate wind-up. In such cases, the areas of seepage 425 of the adhesive layer 42 adhere to the reel side plates, causing blocking between them. When the ACF 40 contains a radical curing adhesive component, a low viscosity radical monomer will usually be included, and this renders the phenomenon more notable.

The phenomenon described above is not limited to ACFs, and occurs in a similar manner whenever the adhesive layer contains components that seep out under compression or under the weight of the film itself. Thus, the same phenomenon is observed with conductive adhesive tapes other than ACFs, and even with general purpose adhesive tapes.

The present invention has been accomplished in light of the circumstances described above, and its object is to provide an adhesive tape and an adhesive tape roll wherein seepage of adhesive components in the adhesive layer of the adhesive tape in the widthwise direction from the sides of the support base is less than in the prior art. It is another object of the invention to provide an adhesive tape and adhesive tape roll wherein adhesion of the adhesive components onto the reel side plates when the adhesive tape is wound onto the reel is less than in the prior art.

### Means for Solving the Problems

In order to achieve the objects stated above, the invention provides an adhesive tape comprising a tape-like support base and a tape-like adhesive layer, wherein the adhesive layer is formed on the main side of the support base and the width of the support base is longer than the width of the adhesive layer.

Since the width of the support base is longer than the width of the adhesive layer according to the invention, seepage of adhesive components in the adhesive layer in the widthwise direction of the adhesive tape from the sides of the support base is less than in the prior art. Moreover, when the adhesive tape is wound onto the reel, the longer width of the support base with respect to the width of the adhesive layer helps prevent contact of the adhesive layer with the reel side walls, by contact between the support base and the reel side walls. This prevents adhesion of the adhesive components onto the reel side plates, compared to the prior art, when the adhesive components seep out from the adhesive layer in the widthwise direction.

The present invention also provides, for the purpose of achieving the aforestated objects, an adhesive tape comprising a tape-like support base having a first main side and a second main side opposite the first main side, and a tape-like adhesive layer having a third main side and a fourth main side opposite the third main side, wherein the adhesive layer is provided on the support base in such a manner that the second main side and third main side are in contact, the width of the support base is longer than the width of the adhesive layer, and the widths of the first, second, third and fourth main sides satisfy the condition represented by the following inequality (1).

a>a′≧b>b′ (1)

In inequality (1), a represents the width of the first main side, a′ represents the width of the second main side, b represents the width of the third main side and b′ represents the width of the fourth main side.

According to the invention, the width of the support base is longer than the width of the adhesive layer, and therefore seepage of adhesive components in the adhesive layer in the widthwise direction of the adhesive tape from the sides of the support base is less than in the prior art. When the adhesive tape is wound around itself, the first main side of the support base and the fourth main side of the adhesive layer are in direct contact between adjacent sections of the adhesive tape. Since the width of the first main side is guaranteed to be longer than the width of the fourth main side, seepage of the adhesive components between adjacent sections of the adhesive tape toward the sides of the support base is even further prevented. This further facilitates pulling out of the adhesive tape.

Moreover, when the adhesive tape is wound onto the reel, the longer width of the support base with respect to the width of the adhesive layer helps prevent contact of the adhesive layer with the reel side walls, by contact between the support base and the reel side walls. This prevents adhesion of the adhesive components onto the reel side plates, compared to the prior art, when the adhesive components seep out from the adhesive layer in the widthwise direction.

The adhesive layer in the adhesive tape of the invention may also contain dispersed conductive particles. This will allow the adhesive tape to function as a conductive adhesive tape for adhesive bonding between electronic parts and circuit boards or between circuit boards, while establishing electrical connection between both conductive members.

The present invention provides an adhesive tape roll obtained by winding an adhesive tape around itself. In the adhesive tape roll, the width of the support base is longer than the width of the adhesive layer, and therefore seepage of adhesive components from the adhesive layer in the widthwise direction of the adhesive tape is less than seepage toward the sides of the support base at adjacent adhesive tape sections according to the prior art. This prevents attachment between the adhesive tape wound around itself, thus allowing easier pull-out of the adhesive tape from the adhesive tape roll, than according to the prior art. Furthermore, when the rolled body is taken up onto a reel, adhesion of the adhesive components onto the reel side plates when the adhesive components seep out from the adhesive layer in the widthwise direction, is also prevented compared to the prior art. As a result, it is possible to reduce blocking between the adhesive tape and reel side walls, compared to the prior art. In addition, handleability is improved since the stored form of the adhesive tape is superior to storage in a sheet form, and supply of the adhesive tape to a bonding apparatus is facilitated.

### EFFECT OF THE INVENTION

According to the invention it is possible to provide an adhesive tape and an adhesive tape roll wherein seepage of adhesive components in the adhesive layer of the adhesive tape in the widthwise direction from the sides of the support base is less than in the prior art. It is also possible to provide an adhesive tape and adhesive tape roll wherein adhesion of the adhesive components onto the reel side plates when the adhesive tape is wound onto the reel is less than in the prior art.

### BRIEF DESCRIPTION OF THE DRAWINGS

FIG. 1 is a schematic cross-sectional view showing an adhesive tape according to a first embodiment of the invention.

FIG. 2 is a schematic cross-sectional view showing an adhesive tape according to a second embodiment of the invention.

FIG. 3 is a schematic perspective view showing an embodiment of an adhesive tape roll wound around a reel.

FIG. 4 is a cross-sectional view of the adhesive tape roll of FIG. 3, along line I-I.

FIG. 5 is a schematic cross-sectional view showing an adhesive tape of the prior art.

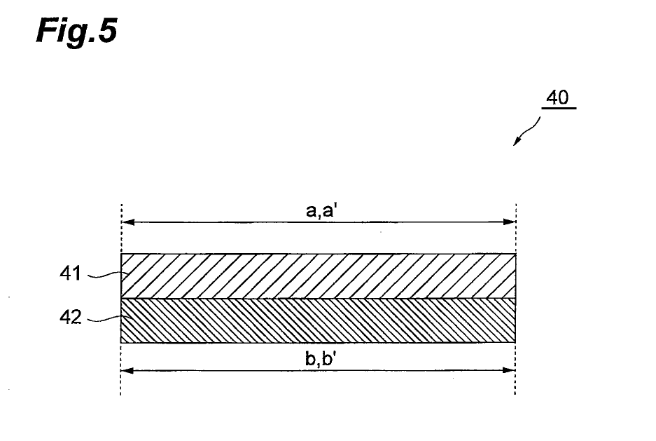

FIG. 6 is a schematic cross-sectional view showing an adhesive tape roll of the prior art.

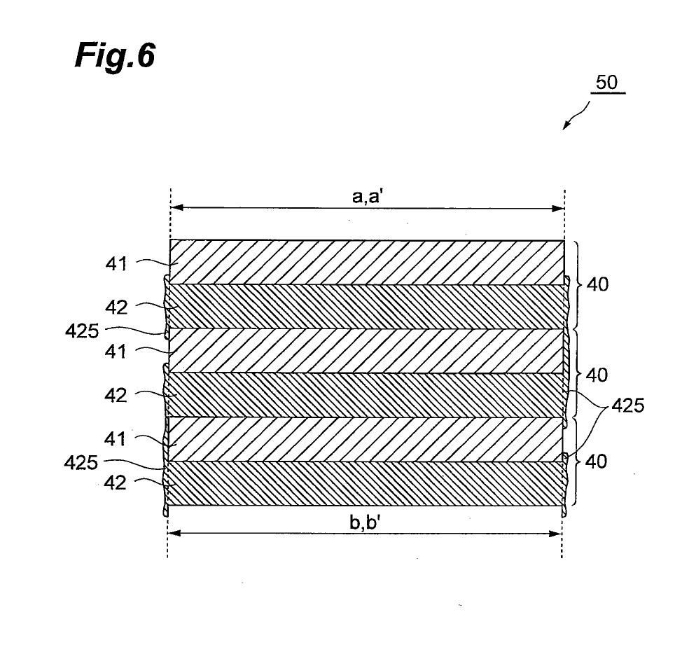

### EXPLANATION OF SYMBOLS

1: Support base, 2: adhesive layer, 10, 20: adhesive tapes, 60: reel.

### BEST MODE FOR CARRYING OUT THE INVENTION

Preferred embodiments of the invention will now be explained in detail, with reference to the accompanying drawings as necessary. Identical elements in the drawings will be referred to by like reference numerals and will be explained only once. The vertical and horizontal positional relationships are based on the positional relationships in the drawings, unless otherwise specified. Also, the dimensional proportions depicted in the drawings are not necessarily limitative. The term “(meth)acrylic acid” used in the present specification refers to “acrylic acid” and its corresponding “methacrylic acid”, while “(meth)acrylate” refers to “acrylate” and its corresponding “methacrylate”.

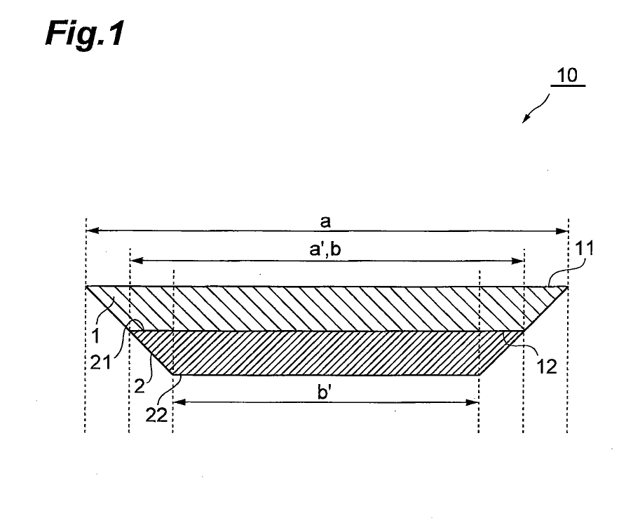

FIG. 1 is a schematic cross-sectional view showing an adhesive tape according to a preferred first embodiment of the invention. FIG. 1 shows a cross-sectional shape orthogonal to the lengthwise direction of the adhesive tape. In FIG. 1, the adhesive tape 10 comprises a tape-like support base 1 and a tape-like adhesive layer 2. The support base comprises a first main side 11 and a second main side 12 opposite the first main side 11, while the adhesive layer 2 comprises a third main side 21 and a fourth main side 22 opposite the third main side 21. The support base 1 and adhesive layer 2 are laminated in such a manner that the second main side 12 and third main side 21 are in contact.

In the adhesive tape 10, the section of the support base 1 with the longest width, i.e. the width a of the first main side 11, is longer than the section of the adhesive layer 2 with the longest width, i.e. the width b of the third main side 21. The second main side 12 of the support base 1 has a width a′ which is the same as the width b of the third main side 21 of the adhesive layer 2. The fourth main side 22 of the adhesive layer 2 has a width b′ which is even shorter than the third main side 21. That is, the relationship between the widths of each main side of each layer for this embodiment satisfies the condition represented by the following inequality (1A).

a>a′=b>b′ (1A)

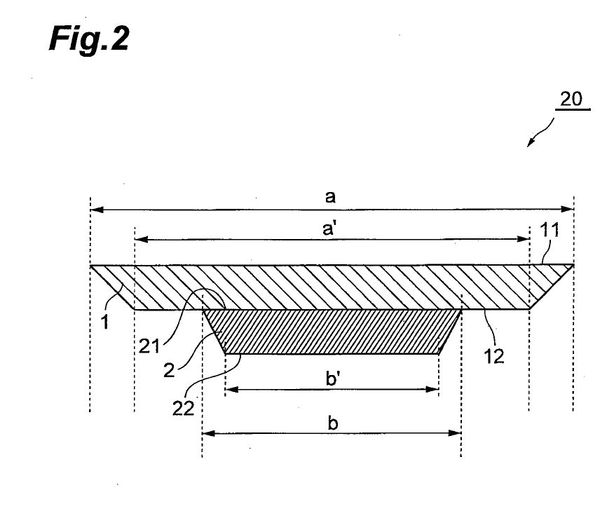

FIG. 2 is a schematic cross-sectional view showing an adhesive tape according to another preferred second embodiment of the invention. FIG. 2 shows a cross-sectional shape orthogonal to the lengthwise direction of the adhesive tape. In FIG. 2, the adhesive tape 20 comprises a tape-like support base 1 and a tape-like adhesive layer 2. The support base comprises a first main side 11 and a second main side 12 opposite the first main side 11, while the adhesive layer 2 comprises a third main side 21 and a fourth main side 22 opposite the third main side 21. The support base 1 and adhesive layer 2 are laminated in such a manner that the second main side 12 and third main side 21 are in contact.

In the adhesive tape 20, the section of the support base 1 with the longest width, i.e. the width a of the first main side 11, is longer than the section of the adhesive layer 2 with the longest width, i.e. the width b of the third main side 21. The second main side 12 of the support base 1 has a width a′ that is longer than the width b of the third main side 21 of the adhesive layer 2. The fourth main side 22 of the adhesive layer 2 has a width b′ which is even shorter than the third main side 21. That is, the relationship between the widths of each main side of each layer for this embodiment satisfies the condition represented by the following inequality (1B).

a>a′>b>b′ (1B)

In the first and second embodiments, the cross-sectional shapes of the support base 1 and adhesive layer 2 are trapezoid, with narrowing width from the support base 1 side toward the adhesive layer 2 side. If the cross-sectional shapes of the support base and adhesive layer thus have narrowing widths from the support base side toward the adhesive layer side, it will be possible to more effectively prevent seepage of the adhesive components from the adhesive layer toward the support base edges, as well as blocking between the reel side plates and the areas of seepage of the adhesive layer. According to the invention, however, there is no restriction to a trapezoid cross-sectional shape for the support base and adhesive layer so long as the width of the support base is longer than the width of the adhesive layer and neither edge of the adhesive layer protrudes outward from the support base edge.

From the viewpoint of ensuring stable adhesive force for adhesion of adherends, the main sides of the support base and adhesive layer are preferably parallel. The cross-sectional shapes of the support base and adhesive layer may be, for example, rectangular, parallelogrammic, or quadrilateral wherein the sides corresponding to the other main sides are parallel. They may also have shapes wherein the sides corresponding to the main sides are parallel and the sides corresponding to the edges of each layer (one or both of the sides) are curved. The cross-sectional shapes of the support base and adhesive layer may be the same or different.

The thickness of the support base 1 is preferably 30-100 μm. If the thickness of the support base 1 is less than 30 μm, the mechanical strength of the support base 1 will tend to be reduced. If the thickness is greater than 100 μm, the volume of the rolled body with respect to the tape length will be increased when an adhesive tape roll is formed, resulting in a shorter rolled body tape length or a larger rolled body, both of which conditions lead to poorer handleability.

The width of the support base 1 is not particularly restricted so long as it is longer than the width of the adhesive layer 2, and it may be 0.5 mm-20 mm, for example, at the longest section.

The material of the support base 1 is not particularly restricted so long as it can be used as a conventional support base in an adhesive tape. As specific examples of materials for the support base 1 there may be mentioned polyethylene terephthalate films, polyethylene naphthalate films, polyethylene isophthalate films, polybutylene terephthalate films, polyolefin-based films, polyacetate films, polycarbonate films, polyphenylene sulfide films, polyamide films, ethylene-vinyl acetate copolymer films, polyvinyl chloride films, polyvinylidene chloride films, synthetic rubber films and liquid crystal polymer films. Of these, polyethylene terephthalate films are preferred from the viewpoint of preventing twisting or deformation during cutting, and obtaining higher mechanical strength.

The support base may be subjected to roughening treatment on one or both of the main sides by a method known in the prior art. Instead of or in addition to such treatment, the main sides may be subjected to release treatment with a release treatment agent such as silicone.

The thickness of the adhesive layer 2 is preferably 8-50 μm. If the thickness of the adhesive layer 2 is smaller than this lower limit, less adhesive will be required for adhesion, and this will tend to lower the adhesive force. If the thickness of the adhesive layer 2 is larger than this upper limit, the amount of adhesive will be increased and more time will be required to remove the unwanted adhesive from the opposing circuits, thus tending to increase the connection resistance.

The adhesive layer 2 is preferably a layer composed of an adhesive composition containing (A1) a thermoplastic resin, (B1) a radical polymerizing compound and (C1) a radical generator (radical polymerization initiator). This will allow bonding to be achieved in a short period of time, and produce a connection structure with higher reliability when circuit members are connected using the cured adhesive composition.

The thermoplastic resin as component (A1) may be any publicly known one, without any particular restrictions. As specific examples of thermoplastic resins there may be mentioned phenoxy resins, polyvinyl formal resins, polystyrene resins, polyvinyl butyral resins, polyester resins, polyamide resins, xylene resins and polyurethane resins. These may be used as single compounds or as combinations of two or more compounds. These thermoplastic resins may optionally have a siloxane bond or fluorine-substituted group in the molecule. When two or more of these thermoplastic resins are used in combination, they may be resins that are fully miscible, or that exhibit microphase separation to an opaque state.

A thermoplastic resin can provide satisfactory film formability for the adhesive composition. Film formability is a mechanical property whereby a liquid adhesive composition solidifies to form a film which does not easily tear, crack or stick. Film formability is said to be satisfactory if handleability as a film is good under normal conditions (for example, ordinary temperature). Phenoxy resins are preferred among the aforementioned thermoplastic resins because of their excellent adhesion, compatibility, heat resistance and mechanical strength.

A phenoxy resin may be obtained either by reacting a bifunctional phenol with an epihalohydrin to a high molecular weight, or by polyaddition of a bifunctional epoxy resin and a bifunctional phenol. For example, a phenoxy resin may be obtained by reacting 1 mol of a bifunctional phenol with 0.985-1.015 mol of epichlorohydrin in a non-reactive solvent at a temperature of 40-120° C., in the presence of an alkali metal hydroxide.

In order to obtain a phenoxy resin by the polyaddition, the bifunctional epoxy resin and bifunctional phenol are reacted in an organic solvent in the presence of a polyaddition catalyst. The mixing ratio of the bifunctional epoxy resin and bifunctional phenol is preferably such that the molar ratio of epoxy groups of the bifunctional epoxy resin and phenolhydroxyl groups of the bifunctional phenol is 1:0.9-1:1.1. As polyaddition catalysts there are preferred one or more catalysts selected from the group consisting of alkali metal compounds, organic phosphorus-based compounds and cyclic amine-type compounds. As organic solvents there are preferably used one or more solvents selected from the group consisting of amide-based, ether-based, ketone-based, lactone-based and alcohol-based sols with boiling points of 120° C. or higher. The reacted solid content in the organic solvent is preferably no greater than 50 parts by weight with respect to 100 parts by weight of the organic solvent, and the reaction temperature is preferably 50-200° C. This will improve the mechanical properties and thermal characteristics of the obtained phenoxy resin.

As examples of bifunctional epoxy resins there may be mentioned bisphenol A-type epoxy resin, bisphenol F-type epoxy resin, bisphenol AD-type epoxy resin, bisphenol S-type epoxy resin, biphenyldiglycidyl ether and methyl-substituted biphenyldiglycidyl ether. These may be used as single compounds or as combinations of two or more compounds.

Bifunctional phenols have two phenolic hydroxyl groups in the molecule, and examples of such bifunctional phenols include bisphenols such as bisphenol A, bisphenol F, bisphenol AD, bisphenol S, bisphenolfluorene, methyl-substituted bisphenolfluorene, dihydroxybiphenyl and methyl-substituted dihydroxybiphenyl, and hydroquinones. These may be used as single compounds or as combinations of two or more compounds.

The phenoxy resin may be modified with radical-polymerizing functional groups or with other reactive compounds (for example, epoxy-modified). A phenoxy resin may be used alone, or two or more different ones may be used in combination.

There are no particular restrictions on the molecular weight of the thermoplastic resin, but a larger molecular weight of the thermoplastic resin will allow easier formation of a film as described hereunder, while the melt viscosity, which affects the flow properties of the adhesive, may be set within a wide range. Since the melt viscosity can be set within a wide range, attachment of the adhesive onto surrounding members can be further prevented when the composition is used for connection of semiconductor elements or liquid crystal devices even when the pitch between elements and wirings is narrow, and therefore the throughput can be improved. For most purposes, the weight-average molecular weight is preferably 5000-150,000 and especially 10,000-80,000. However, a weight-average molecular weight of less than 5000 will tend to result in unsatisfactory film formability when the composition is used as a film as described hereunder, while a weight-average molecular weight of greater than 150,000 will tend to result in inferior compatibility with other components.

The weight-average molecular weight referred to throughout the present specification is the value measured by gel permeation chromatography (GPC) under the following conditions, with calculation based on a standard polystyrene calibration curve.

### (GPC Conditions)

Device: Hitachi L-6000 (trade name of Hitachi, Ltd.)
Detector: L-3300RI (trade name of Hitachi, Ltd.).
Column: GL-R420 Gel pack+GL-R430 Gel pack+GL-R440 Gel pack (total: 3) (trade name of Hitachi Chemical Co., Ltd.)

### Eluent: Tetrahydrofuran

Measuring temperature: 40° C.
Flow rate: 1.75 ml/min

The radical polymerizing compound as component (B1) has a functional group that polymerizes by radicals, and for example, (meth)acrylic acid ester compounds, maleimide compounds and styrene derivatives may be suitably used. The radical polymerizing compound may be used as a polymerizable monomer or polymerizable oligomer, or a polymerizable monomer and polymerizable oligomer may be used in combination. Since the polymerizable oligomer will generally have high viscosity, when a polymerizable oligomer is used the viscosity is preferably adjusted by the use of a polymerizable monomer such as a low-viscosity polymerizable polyfunctional (meth)acrylate.

As (meth)acrylic acid ester compounds there may be used polymerizable oligomers such as epoxy (meth)acrylate oligomers, urethane (meth)acrylate oligomers, polyether (meth)acrylate oligomers, polyester (meth)acrylate oligomers and the like, or polymerizable monomers such as (meth)acrylates. These may be used as single compounds or as combinations of two or more compounds.

As specific examples of (meth)acrylic acid ester compounds there may be mentioned urethane (meth)acrylate, methyl (meth)acrylate, ethyl (meth)acrylate, isopropyl (meth)acrylate, isobutyl (meth)acrylate, ethyleneglycol di(meth)acrylate, diethyleneglycol di(meth)acrylate, triethyleneglycol di(meth)acrylate, trimethylolpropane tri (meth)acrylate, tetramethylolmethane tetra (meth)acrylate, 2-hydroxy-1,3-di(meth)acryloxypropane, 2,2-bis[4-((meth)acryloxymethoxy)phenyl]propane, 2,2-bis[4-((meth)acryloxypolyethoxy)phenyl]propane, dicyclopentenyl (meth)acrylate, tricyclodecanyl (meth)acrylate, dimethyloltricyclodecane di(meth)acrylate, pentaerythritol tri (meth)acrylate, bis((meth)acryloxyethyl)isocyanurate, ε-caprolactone-modified tris((meth)acryloxyethyl)isocyanurate and tris((meth)acryloxyethyl)isocyanurate. These may be used as single compounds or as combinations of two or more compounds.

The adhesive composition of this embodiment preferably further contains, for example, a compound with a dicyclopentenyl group, a compound with a tricyclodecanyl group and/or a compound with a triazine ring as a radical polymerizing compound in addition to those mentioned above, for increased heat resistance.

Preferred maleimide compounds are those with at least two maleimide groups in the molecule. As examples of maleimide compounds with two or more maleimide groups in the molecule there may be mentioned 1-methyl-2,4-bismaleimidebenzene, N,N′-m-phenylenebismaleimide, N,N′-p-phenylenebismaleimide, N,N′-m-toluilenebismaleimide, N,N′-4,4-biphenylenebismaleimide, N,N′-4,4-(3,3′-dimethyl-biphenylene)bismaleimide, N,N′-4,4-(3,3′-dimethyldiphenylmethane)bismaleimide, N,N′-4,4-(3,3′-diethyldiphenylmethane)bismaleimide, N,N′-4,4-diphenylmethanebismaleimide, N,N′-4,4-diphenylpropanebismaleimide, N,N′-4,4-diphenyletherbismaleimide, N,N′-3,3′-diphenylsulfonebismaleimide, 2,2-bis[4-(4-maleimidephenoxy)phenyl]propane, 2,2-bis[3-s-butyl-4,8-(4-maleimidephenoxy)phenyl]propane, 1,1-bis[4-(4-maleimidephenoxy)phenyl]decane, 4,4′-cyclohexylidene-bis[1-(4-maleimidephenoxy)-2-cyclohexyl]benzene and 2,2-bis[4-(4-maleimidephenoxy)phenyl]hexafluoropropane. These may be used as single compounds or as combinations of two or more compounds.

As radical polymerizing compounds there may be used polymers or copolymers of one or more monomer components from among (meth)acrylic acid, (meth)acrylic acid esters and acrylonitrile. It is preferred to also use a copolymer-based acrylic rubber compound containing glycidyl (meth)acrylate with a glycidyl ether group, for excellent stress relaxation. The weight-average molecular weight of the acrylic rubber is preferably at least 200,000 from the viewpoint of increasing the cohesion of the adhesive composition.

If necessary, an appropriate amount of a polymerization inhibitor such as hydroquinone or methyl ether hydroquinone may be added to the adhesive composition.

The radical polymerization initiator used as component (C1) may be a compound that generates free radicals by decomposition upon heating, such as a conventionally known peroxide compound (organic peroxide) or azo compound. When such compounds are used as radical polymerization initiators, one or more compounds selected from among organic peroxides and/or azo compounds may be appropriately selected according to the connection temperature, connecting time and desired pot life.

The radical polymerization initiator preferably has a chlorine ion or organic acid content of no greater than 5000 ppm in order to prevent corrosion of the circuit electrodes (terminals) of the circuit member.

From the standpoint of achieving both high reactivity and a long pot life, an organic peroxide used is preferably an organic peroxide with a 10 hour half-life temperature of 40° C. or higher and a 1 minute half-life temperature of no higher than 180° C., and more preferably an organic peroxide with a 10 hour half-life temperature of 60° C. or higher and a 1 minute half-life temperature of no higher than 170° C.

As organic peroxides, specifically, there may be used one or more selected from the group consisting of diacyl peroxide, peroxy Bicarbonate, peroxy ester, peroxy ketal, dialkyl peroxide, hydroperoxide and silyl peroxide. Preferred among these from the viewpoint of both a long shelf life during storage and high reactivity during use are one or more organic peroxides selected from the group consisting of peroxy ester, peroxy ketal, dialkyl peroxide, hydroperoxide and silyl peroxide. From the viewpoint of obtaining even higher reactivity, the organic peroxide is preferably a peroxy ester and/or peroxy ketal.

As examples of diacyl peroxides there may be mentioned isobutyl peroxide, 2,4-dichlorobenzoyl peroxide, 3,5,5-trimethylhexanoyl peroxide, octanoyl peroxide, lauroyl peroxide, stearoyl peroxide, succinic peroxide, benzoylperoxytoluene and benzoyl peroxide. These may be used as single compounds or as combinations of two or more compounds.

As examples of dialkyl peroxides there may be mentioned α,α′-bis(t-butylperoxy)diisopropylbenzene, dicumyl peroxide, 2,5-dimethyl-2,5-di(t-butylperoxy)hexane and t-butylcumyl peroxide. These may be used as single compounds or as combinations of two or more compounds.

As examples of peroxy dicarbonates there may be mentioned di-n-propylperoxy dicarbonate, diisopropylperoxy dicarbonate, bis(4-t-butylcyclohexyl)peroxy dicarbonate, di-2-ethoxymethoxyperoxy dicarbonate, bis(2-ethylhexylperoxy) dicarbonate, dimethoxybutylperoxy dicarbonate and bis(3-methyl-3-methoxybutylperoxy)dicarbonate. These may also be used as single compounds or as combinations of two or more compounds.

As examples of peroxy esters there may be mentioned cumylperoxy neodecanoate, 1,1,3,3-tetramethylbutylperoxy neodecanoate, 1-cyclohexyl-1-methylethylperoxy neodecanoate, t-hexylperoxy neodecanoate, t-butylperoxy pivalate, 1,1,3,3-tetramethylbutylperoxy-2-ethyl hexanoate, 2,5-dimethyl-2,5-bis(2-ethylhexanoylperoxy)hexane, 1-cyclohexyl-1-methylethylperoxy-2-ethyl hexanoate, t-hexylperoxy-2-ethyl hexanoate, t-butylperoxy-2-ethyl hexanoate, t-butylperoxy isobutyrate, 1,1-bis(t-butylperoxy)cyclohexane, t-hexylperoxyisopropyl monocarbonate, t-butylperoxy-3,5,5-trimethyl hexanoate, t-butylperoxy laurate, 2,5-dimethyl-2,5-bis(m-toluoylperoxy)hexane, t-butylperoxyisopropyl monocarbonate, t-butylperoxy-2-ethylhexyl monocarbonate, t-hexylperoxy benzoate, t-butylperoxy acetate and bis(t-butylperoxy)hexahydroterephthalate. These may be used as single compounds or as combinations of two or more compounds.

As examples of peroxy ketals there may be mentioned 1,1-bis(t-hexylperoxy)-3,3,5-trimethylcyclohexane, 1,1-bis(t-hexylperoxy)cyclohexane, 1,1-bis(t-butylperoxy)-3,3,5-trimethylcyclohexane, 1,1-(t-butylperoxy)cyclododecane and 2,2-bis(t-butylperoxy)decane. These may also be used as single compounds or as combinations of two or more compounds.

As examples of hydroperoxides there may be mentioned diisopropylbenzene hydroperoxide and cumene hydroperoxide. These may also be used as single compounds or as combinations of two or more compounds.

As examples of silyl peroxides there may be mentioned t-butyltrimethylsilyl peroxide, bis(t-butyl)dimethylsilyl peroxide, t-butyltrivinylsilyl peroxide, bis(t-butyl)divinylsilyl peroxide, tris(t-butyl)vinylsilyl peroxide, t-butyltriallylsilyl peroxide, bis(t-butyl)diallylsilyl peroxide and tris(t-butyl)allylsilyl peroxide. These may be used as single compounds or as combinations of two or more compounds.

Any of these radical polymerization initiators may be used as single compounds or as combinations of two or more compounds. A trigger, inhibitor or the like may also be added to the radical polymerization initiator. The aforementioned radical polymerization initiators are preferably used in a microcapsulated form by coating with a polyurethane-based or polyester-based macromolecular compound, in order to obtain an extended pot life.

The mixing proportion of the radical polymerizing compound as component (B1) is preferably 50-250 parts by weight and more preferably 60-150 parts by weight with respect to 100 parts by weight of the thermoplastic resin (A1). If the mixing proportion of the radical polymerizing compound is less than 50 parts by weight the heat resistance of the cured adhesive composition will tend to be reduced, and if it is greater than 250 parts by weight, the film formability of the adhesive composition will tend to be unsatisfactory.

The mixing proportion of the radical polymerization initiator as component (C1) may be appropriately selected according to the desired connection temperature, connection time and pot life. For a connection time of up to 10 seconds, for example, the mixing proportion of the radical polymerization initiator is preferably 0.1-30 parts by weight and more preferably 1-20 parts by weight with respect to 100 parts by weight as the total of the radical polymerizing compound and thermoplastic resin, in order to obtain a sufficient reaction rate. If the mixing proportion of the radical polymerization initiator is less than 0.1 part by weight, the reaction rate will be lowered, tending to hamper curing of the cured adhesive composition. If the mixing proportion of the radical polymerization initiator exceeds 30 parts by weight, the flow property of the adhesive composition may be reduced, the connection resistance may be increased, and the pot life of the adhesive composition may be shortened.

The adhesive layer 2 may be a layer composed of an adhesive composition containing (A1) a thermoplastic resin, (B2) a thermosetting resin and (C2) a latent curing agent. This type of adhesive composition will allow bonding between circuit members with higher adhesive strength.

In this case, the thermoplastic resin as component (A1) may be the same as the thermoplastic resin described above.

An epoxy resin is preferred as the thermosetting resin for component (B2). The epoxy resin may be a single epoxy compound with two or more glycidyl groups in the molecule, or it may be a combination of two or more different ones. Specifically, there may be mentioned bisphenol-type epoxy resins derived from epichlorohydrin and bisphenol A, F, AD or the like, epoxy-novolac resins derived from epichlorohydrin and phenol-novolac or cresol-novolac resins, naphthalene-based epoxy resins with a naphthalene ring-containing skeleton, or glycidylamine-type epoxy resins, glycidyl ether-type epoxy resin, biphenyl-type epoxy resins, alicyclic epoxy resins and the like. These may be used as single compounds or as combinations of two or more compounds. The epoxy resin is preferably a high purity product with the impurity ion (Na⁺, Cl⁻, etc.) and hydrolyzable chlorine content reduced to below 300 ppm, in order to prevent electron migration.

By using the (C2) latent curing agent as the curing agent for the thermosetting resin it will be possible to obtain a longer pot life. When the thermosetting resin is an epoxy resin, the latent curing agent may be an imidazole-based, hydrazide-based, boron trifluoride-amine chelate, sulfonium salt, amineimide, polyamine salt or dicyandiamide curing agent. From the viewpoint of extending the pot life, these curing agents are preferably used in a microcapsulated form by coating with a polyurethane-based or polyester-based macromolecular substance. They may also be used alone or in combinations of two or more, and may also be used in admixture with triggers, inhibitors and the like.

The mixing proportion of the latent curing agent as component (C2) is preferably 0.1-60 parts by weight and more preferably 1-20 parts by weight with respect to 100 parts by weight of the total of the thermoplastic resin and thermosetting resin, in order to achieve a sufficient reaction rate. A mixing proportion of the latent curing agent of less than 0.1 part by weight will tend to lower the reaction rate, reduce the adhesive strength and increase the connection resistance. A mixing proportion of the latent curing agent of greater than 60 parts by weight will tend to reduce the flow property of the adhesive composition, increase the connection resistance and shorten the pot life of the adhesive composition.

The adhesive composition of the invention allows connection to be established by direct contact between opposing circuit electrodes, even without conductive particles. However, dispersed conductive particles are preferably included for more stable connection.

The conductive particles that are included in the adhesive composition of the invention as necessary are not particularly restricted so long as they have conductivity that permits electrical connection to be established. As examples of such conductive particles there may be mentioned metallic particles such as Au, Ag, Ni, Cu or solder, or carbon particles. The conductive particles may consist of nucleus particles covered with one or more layers, with a conductive outermost layer covering them. In this case, the outermost layer is preferably composed mainly of a precious metal such as Au, Ag and/or a platinum family metal rather than a transition metal such as Ni or Cu, and more preferably one or more such precious metals, from the viewpoint of obtaining a superior pot life. Au is most preferred among these precious metals.

The conductive particles may also be further covered with a layer composed mainly of a precious metal, over the surfaces of the particles consisting mainly of a transition metal in the nuclei or over the layer composed mainly of a transition metal covering the nuclei. The conductive particles may comprise insulating particles composed mainly of non-conductive glass, ceramic, plastic or the like as nuclei, and a layer composed mainly of the aforementioned metal or carbon covering the surfaces of the nuclei.

When the conductive particles comprise insulating particle nuclei covered with a conductive layer, preferably the insulating particles are composed mainly of plastic and the outermost layer is composed mainly of a precious metal. This will allow the conductive particles to satisfactorily deform under heat and pressure when the adhesive composition is used as an electrical connection material, such as a circuit-connecting material. Furthermore, the contact area of the conductive particles with the electrodes and terminals will be increased upon connection of the circuit. The connection reliability of the electrical connection material will therefore be further improved. From the same viewpoint, the conductive particles are preferably particles containing a metal that melts under the aforementioned heating, as the major component.

The mean particle size of the conductive particles is preferably 1-18 μm from the viewpoint of dispersibility and conductivity.

When the conductive particles comprise insulating particles as the nuclei covered with a conductive layer, the thickness of the conductive layer is preferably at least 100 angstrom (10 nm) in order to obtain even more satisfactory conductivity. Also, when the conductive particles are particles composed mainly of a transition metal as the nucleus, or have the nucleus covered with a layer composed mainly of a transition metal and the surface thereof covered with an additional layer composed mainly of a precious metal, the thickness of the layer composed mainly of the precious metal as the outermost layer is preferably at least 300 angstrom (30 nm). A thickness of less than 300 angstrom will result in a more rupturable outermost layer. As a result, the exposed transition metal will contact the adhesive component and more easily generate free radicals by the oxidation-reduction activity of the transition metal, thus tending to reduce the pot life. On the other hand, an excessive thickness of the conductive layer will result in a saturated effect, and therefore the thickness is preferably no greater than 1 μm.

There are no particular restrictions on the mixing proportion when conductive particles are used, but it is preferably 0.1-30 parts by volume and more preferably 0.1-10 parts by volume with respect to 100 parts by volume of the component forming the resin when the adhesive composition has been cured. If the value is less than 0.1 part by volume it will tend to be difficult to achieve satisfactory conductivity, while if it exceeds 30 parts by volume there will be a greater risk of shorting between circuits. The mixing proportion of the conductive particles (by volume) is determined based on the volume of each component before curing of the adhesive composition at 23° C. The volume of each component may be measured by a method of calculating the volume from the weight based on the specific gravity, or a method of loading the component into a vessel such as a graduated cylinder containing an appropriate solvent (water, alcohol or the like) that thoroughly wets the component without dissolving or swelling it, and calculating based on the increased volume.

The adhesive composition of this embodiment may also contain other added materials as suited for the purpose of use, in addition to those mentioned above. For example, coupling agents and adhesion aids such as adhesiveness improvers and leveling agents may be added to the adhesive composition as appropriate. Such additives can result in more satisfactory adhesion and handleability. The adhesive composition of the invention may further contain rubber. Addition of rubber can help to relax stress and improve the adhesive property. A stabilizer may also be added to the adhesive composition in order to control the curing speed and impart storage stability. The adhesive composition may still further contain added fillers, softening agents, accelerators, age inhibitors, coloring agents, flame retardants, thixotropic agents, phenol resins, melamine resins, isocyanates and the like.

The adhesive composition preferably includes a filler to improve the connection reliability. The filler used may be any one with an insulating property and that has a maximum size less than the mean particle size of the conductive particles. The mixing proportion of the filler is preferably 5-60 parts by volume with respect to 100 parts by volume of the component forming the resin when the adhesive composition has been cured. If the mixing proportion of the filler is greater than 60 parts by volume the effect of improved reliability will tend to be saturated, while if it is less than 5 parts by volume the effect of addition of the filler will tend to be minimal.

Preferred coupling agents, from the viewpoint of adhesion, are compounds containing one or more groups selected from among ketimine, vinyl, acrylic, amino, epoxy and isocyanate groups. Specifically, as silane coupling agents with acrylic groups there may be mentioned (3-methacryloxypropyl)trimethoxysilane, (3-acryloxypropyl)trimethoxysilane, (3-methacryloxypropyl)dimethoxymethylsilane and (3-acryloxypropyl)dimethoxymethylsilane, and as silane coupling agents with amino groups there may be mentioned N-β(aminoethyl)γ-aminopropyltrimethoxysilane, N-β(aminoethyl)γ-aminopropylmethyldimethoxysilane, γ-aminopropyltriethoxysilane and N-phenyl-γ-aminopropyltrimethoxysilane. As ketimine-containing silane coupling agents there may be mentioned those obtained by reaction of ketone compounds such as acetone, methyl ethyl ketone and methyl isobutyl ketone with the aforementioned amino group-containing silane coupling agents. As silane coupling agents with epoxy groups there may be mentioned γ-glycidyloxypropyltrimethoxysilane, γ-glycidyloxypropyltriethoxysilane, γ-glycidyloxypropyl-methyldimethoxysilane and γ-glycidyloxypropyl-methyldiethoxysilane.

The mixing proportion of the coupling agent is preferably 0.1-20 parts by weight with respect to 100 parts by weight as the total of the other components in the adhesive composition. If the mixing proportion of the coupling agent is less than 0.1 part by weight, a practical effect of addition may not be obtained. If the mixing proportion of the coupling agent is greater than 20 parts by weight, the film formability of the adhesive layer will be reduced when the adhesive layer composed of the adhesive composition is formed on the support base, thus tending to lower the film thickness and strength.

Each of the components mentioned above may be combinations of any of the examples thereof mentioned. Also, each of the components may be synthesized by ordinary methods or obtained commercially.

The difference between the width at the longest section of the support base and the width at the longest section of the adhesive layer in the adhesive tape may be appropriately adjusted by modifying the cross-sectional shape of the support base, the types of adhesive components in the adhesive layer and the thickness of each layer, so that the intended effect of the invention can be achieved. The difference in the widths of the layers is preferably 0.05-2 mm and more preferably 0.1-2 mm. If the difference in width is less than 0.05 mm, the intended effect of the invention will tend to be less than when it is within the range of 0.05-2 mm. Also, if the difference in the widths of the layers exceeds 2 mm, the volume ratio of the adhesive layer with respect to the volume of the support base will be reduced and the amount of adhesive per unit volume of adhesive tape will tend to be reduced, compared to when the difference is within the range of 0.05-2 mm.

For the first and second embodiments, the preferred difference in the widths of the layers is represented by the following inequality (2).

0.05≦a−b≦2(units:mm) (2)

The adhesive tape 10 may be formed by the following method. Specifically, first the main side of the support base is coated with the adhesive composition by an ordinary procedure, and then the solvent is volatilized off to obtain a supply roll which is a rolled laminated body (adhesive sheet) comprising a support base and an adhesive layer. Next, the cutting blade of a cutter is inserted from the first main side a of the support base 1 while pulling out the supply roll, and is used to penetrate to the fourth main side b′ side of the adhesive layer 2 to obtain a belt-shaped adhesive tape 10 comprising the support base 1 and adhesive layer 2. Alternatively, the cutting blade is inserted from the fourth main side b′ of the adhesive layer 2 and used to penetrate to the first main side a of the support base 1. Here, the insertion angle for the cutting blade may be adjusted so as to obtain the adhesive tape 10 with the cross-sectional shape shown in FIG. 1.

An adhesive tape 20 may be formed by the following method. Specifically, first a sheet-like support base supply roll is cut into a band to obtain a support base 1. During cutting, the insertion angle for the cutting blade is adjusted so as to obtain the support base 1 with the cross-sectional shape shown in FIG. 1. Separately, a releasable base is coated with the adhesive composition and the solvent is volatilized off to obtain a supply roll comprising an adhesive layer laminated on the releasable base. The supply roll is cut into a band to obtain a laminated tape comprising a band-shaped adhesive layer 2 on a band-shaped releasable base. During cutting, the insertion angle for the cutting blade is adjusted so as to obtain the adhesive layer 2 with the cross-sectional shape shown in FIG. 2. Next, the releasable base is released from the adhesive layer 2 and the released adhesive layer 2 is positioned and contact bonded on the support base 1, to form an adhesive tape 20 having the cross-sectional shape shown in FIG. 2.

In the adhesive tape of the invention described above, the width of the support base is longer than the width of the adhesive layer. Thus, even when the adhesive components seep out from the adhesive layer, this can reduce seepage of adhesive components to the edges of the support base. This will help prevent the area areas of seepage from the adhesive layer from flowing down onto the edges of the support base, when the support base is situated below. As a result, it will be possible to release the adhesive layer from the support base more easily than in the prior art.

As demonstrated by this first embodiment, using equal lengths for the width a′ of the second main side 12 of the support base 1 and the width b of the third main side 21 of the adhesive layer 2 facilitates formation of adhesive tape, compared to when the width a′ is longer or shorter than the width b.

Furthermore, as demonstrated by the second embodiment, using a longer length for the width a′ of the second main side 12 of the support base 1 with respect to the width b of the third main side 21 of the adhesive layer 2 can even more effectively prevent run-off of seeping adhesive component onto the support base 1 edges, compared to when the width a′ is shorter than or equal to the width b.

The adhesive tape of the invention may be used in an anisotropic conductive film, a conductive adhesive tape such as an isotropic conductive film, or an insulating adhesive film such as an underfill film.

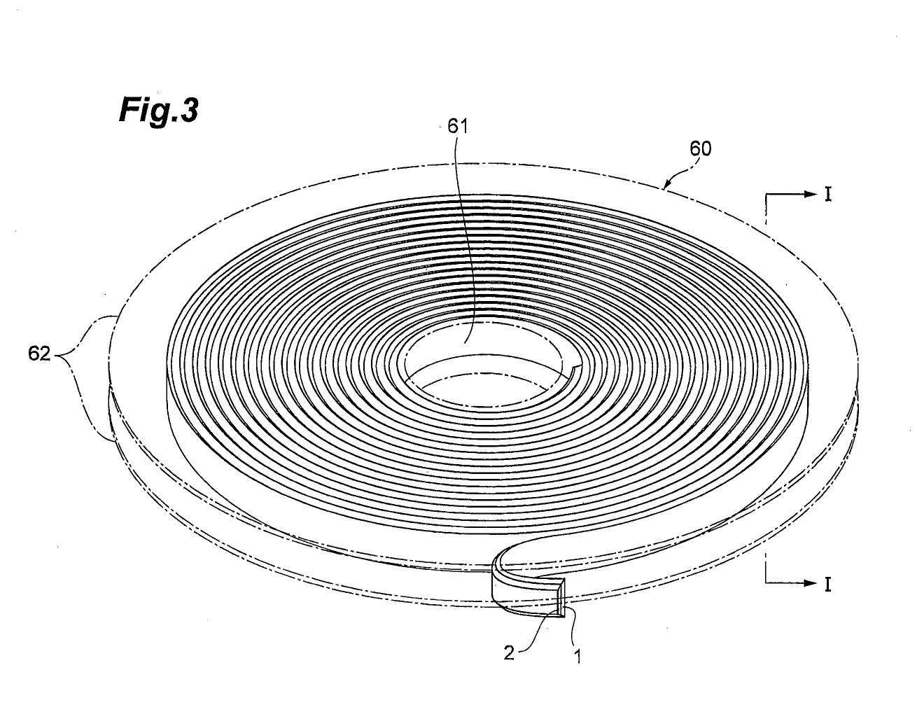

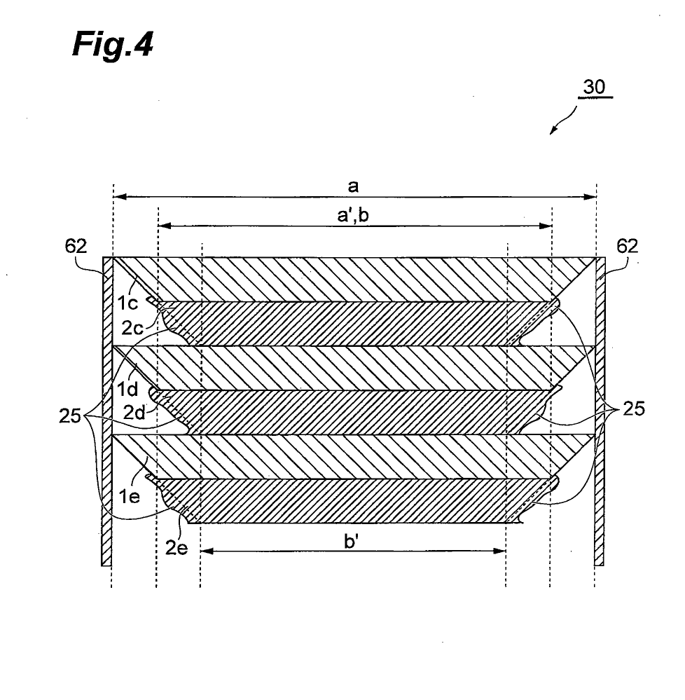

FIG. 3 is a schematic perspective view of an adhesive tape roll comprising an adhesive tape 10 according to the first embodiment of the invention rolled around itself. FIG. 4 is a cross-sectional view of the adhesive tape roll of FIG. 3, along line I-I.

As shown in FIG. 4, the adhesive tape 10 is wound around a reel 60 having side plates 62 attached on both sides of a winding core 61, with the support base 1 on the outer side, to form an adhesive tape roll. By winding the adhesive tape 10 around the reel 60, it is possible to improve the handleability of the adhesive tape 10 by facilitating its mounting onto conventionally used bonding apparatuses. During wind-up, the adhesive layers 2c, 2d shown in FIG. 4 are compressed against the support bases 1c and 1d and against the support bases 1d and 1e. The dimensional variation that occurs with time thus causes the adhesive component to seep out from the adhesive layer 2, producing areas of seepage 25.

As mentioned above, the width of the support base 1 in the adhesive tape 10 of the invention is longer than the width of the adhesive layer 2. Even when the adhesive component seeps out, therefore, contact of the areas of seepage 25 with the side plates 62 is minimized. As a result, it is possible to prevent blocking between the areas of seepage 25 of the adhesive component, and the side plates 62 of the reel 60. Moreover, even when seepage is such that the areas of seepage 25 are on the edges or the main side of the support base 1, it is possible to sufficiently avoid, for example, a situation where the areas of seepage 25 from the adhesive layers 2c, 2d in FIG. 4 cover the sides of the support base 1d and become joined together. As a result, the adhesive tape 10 can be pulled out from the reel 60 more easily than in the prior art.

The embodiments described above are preferred embodiments of the invention, but the invention is not limited thereto. The invention may also be applied in a variety of modifications so long as the gist thereof is maintained.

### EXAMPLES

The present invention will now be explained in greater detail through the following examples, with the understanding that these examples are in no way limitative on the invention.

### Example 1

First, 400 parts by weight of polycaprolactonediol with a weight-average molecular weight of 800, 131 parts by weight of 2-hydroxypropyl acrylate, 0.5 part by weight of dibutyltin dilaurate as a polymerization inhibitor were combined, and the mixture was stirred while heating at 50° C. Next, 222 parts by weight of isophorone diisocyanate was added dropwise to the obtained mixture and the temperature was raised to 80° C. while stirring for urethanation reaction. Upon confirming at least a 99% isocyanate group reaction rate, the reaction mixture was cooled to obtain urethane acrylate.
Next, 50 parts by weight of a bisphenol A-type phenoxy resin (weight-average molecular weight: 45,000, “PKHC”, trade name of Union Carbide) as a thermoplastic resin, 35 parts by weight of the aforementioned urethane acrylate and 15 parts by weight of pentaerythritol triacrylate (“A-TMM-3L”, trade name of Shin-Nakamura Chemical Co., Ltd.) as radical polymerizing compounds, 5 parts by weight of an organic peroxide (t-hexylperoxy2-ethyl hexanoate) as a radical polymerization initiator and 3 parts by volume of conductive particles (mean particle size: 10 μm) with respect to 100 parts by volume of the total adhesive composition, were dissolved and/or dispersed in methyl ethyl ketone (MEK), to prepare an MEK solution of the adhesive composition. The organic peroxide was used as a 50 wt % DOP solution (“PERCURE HO”, trade name of NOF Corp.). The conductive particles had a nickel layer with a thickness of 0.2 μm formed on the surfaces of particles with polystyrene nuclei, and a gold layer with a thickness of 0.04 μm formed on the outside of the nickel layer.

The obtained MEK solution of the adhesive composition was evenly coated onto the main side of a PET film with a thickness of 80 μm. The main side of the PET film on which the adhesive composition solution was coated had been pre-treated for roughening or release treatment. The solvent was volatilized off by hot air at 70° C. for 10 minutes, to obtain an adhesive sheet comprising an adhesive layer formed on a PET film as the support base. The thickness of the adhesive layer was 30 μm.

The adhesive sheet was wound around itself using a known adhesive tape roll-forming apparatus while being simultaneously cut in the lengthwise direction, to prepare an adhesive tape roll with a wound length of 50 m. A cutting blade was set in the adhesive tape roll-forming apparatus for cutting of the adhesive sheet, and in order to produce an adhesive layer with a narrower width than the width of the support base, the cutting blade was adjusted to cut at an angle of +45° from the perpendicular direction with respect to the main side of the adhesive layer. In the obtained adhesive tape roll, the width a of the first main side of the support base was 3.0 mm, the width a′ of the second main side of the support base and the width b of the third main side of the adhesive layer were 2.9 mm, and the width b′ of the fourth main side of the adhesive layer was 2.8 mm.

Ten wound adhesive tape rolled bodies were placed in a thermostatic bath with an air atmosphere kept at a temperature of 30° C., with one of the sides of the rolled body facing downward, and this condition was maintained for 24 hours. When the presence of seepage of the adhesive component from the sides of the adhesive tape roll was then examined, no seepage was found in any of the 10 rolls.

### Comparative Example 1

An adhesive sheet was formed in the same manner as Example 1. The adhesive sheet was wound around itself using the aforementioned adhesive tape roll-forming apparatus while being simultaneously cut in the lengthwise direction, to prepare an adhesive tape roll with a wound length of 50 m. A cutting blade was set in the adhesive tape roll-forming apparatus for cutting of the adhesive sheet, and the cutting blade was adjusted to cut in a perpendicular direction with respect to the main side of the adhesive layer. In the obtained adhesive tape roll, the width a of the first main side of the support base, the width a′ of the second main side thereof, the width b of the third main side of the adhesive layer and the width b′ of the fourth main side thereof were all 3.0 mm.

Ten wound adhesive tape rolled bodies were placed in a thermostatic bath with an air atmosphere kept at a temperature of 30° C., with one of the sides of the rolled body facing downward, and this condition was maintained for 24 hours. When the presence of seepage of the adhesive component from the sides of the adhesive tape roll was then examined, seepage was found in 7 of the 10 rolls.

1. An adhesive tape comprising a tape-like support base and a tape-like adhesive layer,
the adhesive layer being formed on the main side of the support base, and
the width of the support base being longer than the width of the adhesive layer.

2. An adhesive tape comprising
a tape-like support base having a first main side and a second main side opposite the first main side, and
a tape-like adhesive layer having a third main side and a fourth main side opposite the third main side,
the adhesive layer being provided on the support base in such a manner that the second main side and third main side are in contact,
the width of the support base being longer than the width of the adhesive layer, and
the widths of the first, second, third and fourth main sides satisfying the condition represented by the following inequality (1).
a>a′≧b>b′ (1)
(In inequality (1), a represents the width of the first main side, a′ represents the width of the second main side, b represents the width of the third main side and b′ represents the width of the fourth main side.)

3. An adhesive tape according to claim 1, the adhesive layer containing dispersed conductive particles.

4. An adhesive tape roll obtained by winding an adhesive tape according to claim 1 around itself.
